(19) United States
(12) Patent Application Publication
(10) Pub. No.: US 2024/0388015 A1
(43) Pub. Date: Nov. 21, 2024

(54) WIRE HARNESS AND PROTECTOR

(71) Applicant: SUMITOMO WIRING SYSTEMS, LTD., Mie (JP)

(72) Inventor: Kohei HASHIMOTO, Mie (JP)

(21) Appl. No.: 18/695,958

(22) PCT Filed: Sep. 22, 2022
(86) PCT No.: PCT/JP2022/035532

§ 371 Date: Mar. 27, 2024

(30) Foreign Application Priority Data
Oct. 5, 2021 (JP) 2021-164263

(51) Int. Cl. H01R 4/70; B60R 16/02; H01B 7/00; H01R 4/30

(52) U.S. Cl. CPC H01R 4/70; H01R 4/305; B60R 16/0215; H01B 7/0045

(57) ABSTRACT

A protector includes: a protector main body that includes a first arrangement portion and a second arrangement portion; a first cover that covers the first arrangement portion; and a second cover that covers the second arrangement portion. A first electric wire is arranged in the first arrangement portion. A connection portion between the first and second terminals is arranged in the second arrangement portion. The second cover is formed separately from the protector main body and the first cover. The first cover includes a first locking portion. The second cover includes a second locking portion that lockingly engages with the first locking portion. Furthermore, the second cover is configured to be capable of rotating about a contact portion between the first locking portion and the second locking portion as an axis of rotation from an open position to a closed position.

### TECHNICAL FIELD

The present disclosure relates to a wire harness and a protector.

### BACKGROUND

For example, Patent Document 1 discloses a wire harness including a plurality of electric wire members that are electrically connected to one another, and a protector that houses the electric wire members. In the wire harness disclosed in Patent Document 1, the protector is formed from a protector main body and a cover that is attached to the protector main body. In the wire harness disclosed in Patent Document 1, the terminals of the electric wire members are connected to one another inside the protector.

### PRIOR ART DOCUMENT

### Patent Document

Patent Document 1: JP 2016-019434 A

### SUMMARY OF THE INVENTION

### Problems to be Solved

A wire harness as described above may be installed to a vehicle or the like, for example, by fixing the protector to a vehicle, connecting the electric wire members to one another inside the protector main body, and then attaching the cover to the protector main body. In the case of the protector disclosed in Patent Document 1, in order to attach the cover to the protector main body, cover-side locking portions need to be lockingly engaged with a plurality of locking portions provided on the side walls of the protector main body. Thus, it is difficult to attach the cover using one hand, and the work of attaching the cover becomes especially difficult in a case such as that in which the cover is to be attached to a high position.

One aim of the present disclosure is to provide a wire harness and a protector with which workability during work of attaching a cover after electric wire members have been connected to one another can be improved.

### Means to Solve the Problem

A wire harness according to the present disclosure is a wire harness including: a first electric wire member that includes a first terminal and a first electric wire that is connected to the first terminal; and a protector that houses the first electric wire member therein, the first terminal being connected, inside the protector, to a second terminal that is included in a second electric wire member, wherein the protector includes: a protector main body that includes a first arrangement portion in which the first electric wire is arranged, and a second arrangement portion in which a connection portion between the first and second terminals is arranged; a first cover that covers the first arrangement portion; and a second cover that is formed separately from the protector main body and the first cover, and that covers the second arrangement portion, the first cover includes a first locking portion, the second cover includes a second locking portion that lockingly engages with the first locking portion, and the second cover is configured to be capable of rotating about a contact portion between the first and second locking portions as an axis of rotation from an open position to a closed position in which the second cover covers the second arrangement portion.

Furthermore, a protector according to the present disclosure is a protector housing therein a first electric wire member that includes a first terminal and a first electric wire that is connected to the first terminal, the first terminal being connected, inside the protector, to a second terminal that is included in a second electric wire member, the protector including: a protector main body that includes a first arrangement portion in which the first electric wire is arranged, and a second arrangement portion in which a connection portion between the first and second terminals is arranged; a first cover that covers the first arrangement portion; and a second cover that is formed separately from the protector main body and the first cover, and that covers the second arrangement portion, the first cover including a first locking portion, the second cover including a second locking portion that lockingly engages with the first locking portion, and the second cover being configured to be capable of rotating about a contact portion between the first and second locking portions as an axis of rotation from an open position to a closed position in which the second cover covers the second arrangement portion.

### Effect of the Invention

According to the wire harness and the protector according to the present disclosure, workability during work of attaching a cover after electric wire members have been connected to one another can be improved.

### BRIEF DESCRIPTION OF THE DRAWINGS

FIG. 1 is an exploded perspective view illustrating a wire harness according to an embodiment.

FIG. 2 is a cross-sectional view illustrating the wire harness according to the embodiment.

FIG. 3 is a perspective view illustrating a protector main body in the embodiment.

FIG. 4 is an enlarged cross-sectional view illustrating an engagement relationship between a first cover and a second cover in the embodiment.

FIG. 5 is an enlarged cross-sectional view illustrating an engagement relationship between the first cover and the second cover in the embodiment.

FIG. 6 is a side view illustrating the protector main body in the embodiment.

FIG. 7 is a perspective view illustrating a state in which the second cover is in an open position in the wire harness according to the embodiment.

### DETAILED DESCRIPTION TO EXECUTE THE INVENTION

### Description of Embodiments of Present Disclosure

First, aspects of embodiment of the present disclosure will be listed and described.
[1] A wire harness according to the present disclosure is a wire harness including:
   a first electric wire member that includes a first terminal and a first electric wire that is connected to the first terminal; and a protector that houses the first electric wire member therein, the first terminal being connected, inside the protector, to a second terminal that is included in a second electric wire member, wherein the protector includes: a protector main body that includes a first arrangement portion in which the first electric wire is arranged, and a second arrangement portion in which a connection portion between the first and second terminals is arranged; a first cover that covers the first arrangement portion; and a second cover that is formed separately from the protector main body and the first cover, and that covers the second arrangement portion, the first cover includes a first locking portion, the second cover includes a second locking portion that lockingly engages with the first locking portion, and the second cover is configured to be capable of rotating about a contact portion between the first and second locking portions as an axis of rotation from an open position to a closed position in which the second cover covers the second arrangement portion.

According to this configuration, first, the first cover is attached in a state in which the first electric wire member is arranged in the protector main body. Here, the first terminal is exposed from the protector as a result of the second cover being removed. Thus, the first and second terminals can be connected to one another inside the protector main body in a state in which the first cover is attached to the protector main body. Furthermore, the second cover can then be attached to the protector main body to cover the connection portion between the first and second terminals with the second cover. Upon attaching the second cover, the second locking portion is lockingly engaged with the first locking portion, and the second cover is rotated to the closed position about the contact portion between the first and second locking portions as the axis of rotation. Thus, the work of attaching the second cover can be performed using one hand, and the workability during the work of attaching the second cover can be improved.
[2] The first locking portion includes a slit that is provided in the first cover, and the second locking portion is configured to be capable of being inserted into the slit.

According to this configuration, the second cover can be rotated to the closed position about a contact portion between the slit and the second locking portion as the axis of rotation after the second locking portion is inserted into the slit.
[3] The first locking portion can hold the second cover in the open position in a state in which the axis of rotation intersects a horizontal plane.

According to this configuration, the workability during the work of attaching the second cover can be further improved because the second cover can be held in the open position in a state in which the second locking portion is inserted into the slit.
[4] The slit is formed between a first wall portion and a second wall portion that face one another, the second wall portion is provided between the first wall portion and an end portion of the first cover that faces the second cover, a tip portion of the first wall portion includes an inclined portion that is inclined toward the second wall portion-side, and the second locking portion is in contact with the inclined portion in a state in which the second cover is in the closed position. According to this configuration, in the state in which the second cover is in the closed position, the second locking portion can be held by the inclined portion so that the second locking portion does not separate from the slit.
[5] A bolt is fixed to the protector main body, the first terminal includes a through-hole into which the bolt is inserted, and the first and second terminals are connected to one another by the bolt and a nut that is screwed onto the bolt.

According to this configuration, because the first terminal includes the through-hole, into which the bolt is inserted, the movement of the first terminal can be restricted even in a state, prior to the fastening of the nut, in which the bolt is merely inserted into the through-hole. Accordingly, the first electric wire member can be more reliably held against the protector main body in a state before the nut is fastened to the bolt. Due to this, the wire harness can be transported and distributed with ease in a state in which the first electric wire member has been attached to the protector main body and the second electric wire member is yet to be connected to the first electric wire member.
[6] The second arrangement portion includes a rotation-restricting portion that restricts a rotation of the second terminal about the bolt, and the rotation-restricting portion is located further inward in the protector than an end portion of the protector from which the second electric wire member is led out is. According to this configuration, co-rotation of the second terminal during fastening or removal of the nut can be suppressed by the rotation-restricting portion.
[7] The first arrangement portion and the first cover sandwich the first electric wire member.

According to this configuration, the first electric wire member can be more reliably held in the protector. Due to this, the wire harness can be transported and distributed with ease in a state in which the first electric wire member has been attached to the protector main body and the second electric wire member is yet to be connected to the first electric wire member.
[8] The first arrangement portion includes a movement-restricting portion that restricts a movement of the first electric wire member in a length direction.

According to this configuration, the first electric wire member can be more reliably held in the protector by the movement-restricting portion. Due to this, the wire harness can be transported and distributed with ease in a state in which the first electric wire member has been attached to the protector main body and the second electric wire member is yet to be connected to the first electric wire member.
[9] The first arrangement portion includes a first bottom wall, and two mutually-facing first side walls that project from opposite side edges of the first bottom wall, the second arrangement portion includes a second bottom wall, and two mutually-facing second side walls that project from opposite side edges of the second bottom wall, the movement-restricting portion is provided to at least the first side walls of the first arrangement portion, and a height of the first side walls is set higher than a height of the second side walls.

According to this configuration, it can be readily ensured that the movement-restricting portion provided to the first side walls has sufficient length, and, due to this, the restriction of the movement of the first electric wire member by the movement-restricting portion can be realized more suitably. Furthermore, by reducing the height of the second side walls, a situation can be prevented in which the second side walls interfere with work of connecting the first and second terminals to one another. This accordingly contributes to an improvement in workability during work of connecting the first and second terminals to one another.
[10] The first electric wire member includes a corrugated tube that covers an outer circumference of the first electric wire, the corrugated tube has a bellows structure in which a ring-shaped projection and a ring-shaped recess that has a smaller outer diameter than the projection are provided alternatingly in the length direction, and the movement-restricting portion is an engaging projection that engages with the recess.

According to this configuration, the movement of the first electric wire member, which includes the corrugated tube, in the length direction can be restricted as a result of the engaging projection serving as the movement-restricting portion engaging with a recess of the corrugated tube.
[11] The protector includes a lead-out port through which the first electric wire member is led out to the outside of the protector, and an insulating coating of the first electric wire is located inside the lead-out port.

According to this configuration, an exposed part of a core wire in the first electric wire can be arranged inside the protector.
[12] The second cover includes a first end portion that includes the second locking portion, a second end portion on the opposite side from the first end portion, and an engaging portion, the second arrangement portion includes a lock portion that engages with the engaging portion in a state in which the second cover is in the closed position, and the lock portion is located closer to the second end portion than the connection portion is.

According to this configuration, one end portion of the second cover can be held by the second locking portion and the first locking portion being locked to one another, and the other end portion of the second cover can be held by the engaging portion and the lock portion engaging with one another. Thus, both end portions of the second cover can be held, and, due to this, the state of attachment of the second cover can be stabilized.
[13] The first cover is connected to the first arrangement portion via a hinge portion, and the first cover is configured to be capable of rotating about the hinge portion between an open position and a closed position in which the first cover covers the first arrangement portion.

According to this configuration, the first cover, which can open and close relative to the first arrangement portion, can be formed integrally with the first arrangement portion.
[14] Furthermore, a protector according to the present disclosure is a protector housing therein a first electric wire member that includes a first terminal and a first electric wire that is connected to the first terminal, the first terminal being connected, inside the protector, to a second terminal that is included in a second electric wire member, the protector including: a protector main body that includes a first arrangement portion in which the first electric wire is arranged, and a second arrangement portion in which a connection portion between the first and second terminals is arranged; a first cover that covers the first arrangement portion; and a second cover that is formed separately from the protector main body and the first cover, and that covers the second arrangement portion, the first cover including a first locking portion, the second cover including a second locking portion that lockingly engages with the first locking portion, and the second cover being configured to be capable of rotating about a contact portion between the first and second locking portions as an axis of rotation from an open position to a closed position in which the second cover covers the second arrangement portion.

According to this configuration, first, the first cover is attached in a state in which the first electric wire member is arranged in the protector main body. Here, the first terminal is exposed from the protector as a result of the second cover being detached. Thus, the first and second terminals can be connected to one another inside the protector main body in a state in which the first cover is attached to the protector main body. Furthermore, the second cover can then be attached to the protector main body to cover the connection portion between the first and second terminals with the second cover. Upon attaching the second cover, the second locking portion is lockingly engaged with the first locking portion, and the second cover is rotated to the closed position about the contact portion between the first and second locking portions as the axis of rotation. Thus, the work of attaching the second cover can be performed using one hand, and the workability during the work of attaching the second cover can be improved.

### Details of Embodiments of Present Disclosure

Specific examples of the wire harness and the protector according to the present disclosure will be described in the following with reference to the drawings. In the drawings, some configurations may be illustrated in an exaggerated or simplified manner for convenience of explanation. Also, the dimensional ratios between portions may differ between drawings. Furthermore, the term “parallel” in the present description not only includes strict parallelism but also includes substantial parallelism to the extent that the actions and effects in the present embodiment are achieved. The term “orthogonal” in the present description not only includes strict orthogonality but also includes substantial orthogonality to the extent that the actions and effects in the present embodiment are achieved.

Note that the term “facing” in the present description refers to two surfaces or members being positioned in front of one another, and not only includes a case in which two surfaces or members are positioned in front of one another entirely but also includes a case in which two surfaces or members are positioned in front of one another partially. Furthermore, the term “facing” in the present description includes both a case in which there is another member between two portions and a case in which nothing is in between the two portions.

### (Configuration of Wire Harness 10)

A wire harness 10 electrically connects, to one another, electric devices installed in a hybrid vehicle, an electric vehicle, or the like, for example.

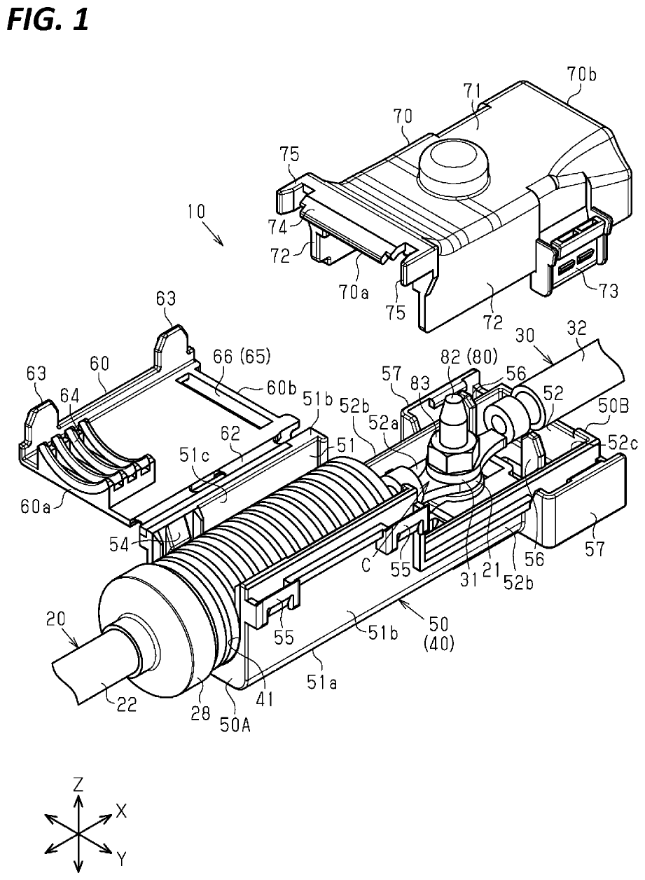

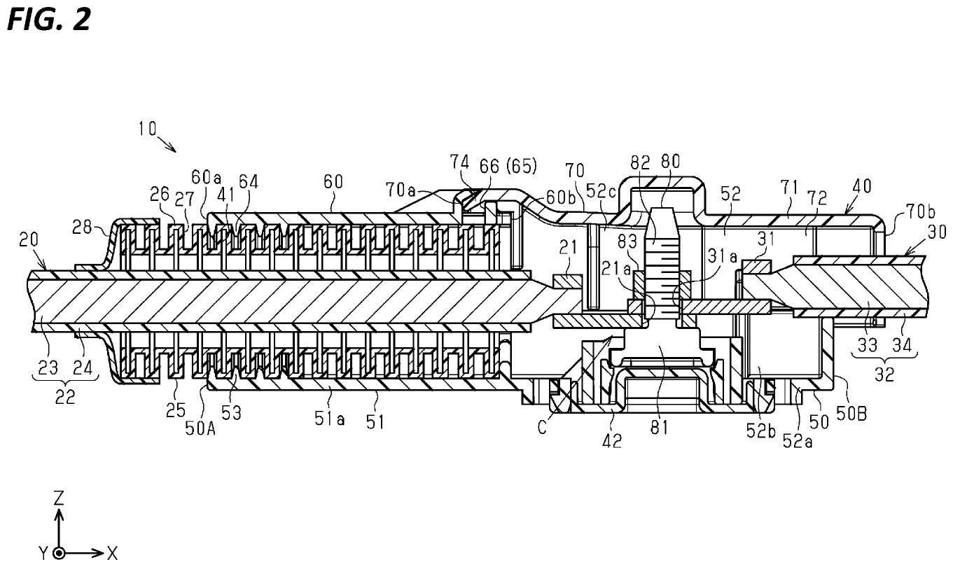

As illustrated in FIGS. 1 and 2, the wire harness 10 includes a first electric wire member 20, a second electric wire member 30, and a protector 40 that houses the first electric wire member 20 and the second electric wire member 30 therein. The first electric wire member 20 and the second electric wire member 30 are electrically connected inside the protector 40. For example, the first electric wire member 20 and the second electric wire member 30 are drawn out from the protector 40 in mutually opposite directions along a length direction X of the first electric wire member 20.

Hereinafter, the length direction X of the first electric wire member 20 is simply referred to as the “length direction X.”

### (Configuration of First Electric Wire Member 20)

As illustrated in FIG. 2, the first electric wire member 20 includes a first terminal 21, a first electric wire 22 that is connected to the first terminal 21, and a corrugated tube 25 that surrounds the outer circumference of the first electric wire 22. The corrugated tube 25 is drawn out from the protector 40.

### (Configuration of First Terminal 21)

The first terminal 21 includes a circular through-hole 21a. For example, metal materials such as copper, copper alloys, aluminum, aluminum alloys, and stainless steel can be used as the material of the first terminal 21.

### (Configuration of First Electric Wire 22)

The first electric wire 22 includes a core wire 23 that is formed from a conductor, and an insulating coating 24 that covers the outer circumference of the core wire 23. For example, metal materials such as those based on copper, aluminum, etc., can be used as the material of the core wire 23. For example, synthetic resins containing, as a main component thereof, a polyolefin-based resin such as a cross-linked polyethylene or a cross-linked polypropylene can be used as the material of the insulating coating 24.

The core wire 23 is exposed from the insulating coating 24 in an end portion of the first electric wire 22. The core wire 23 exposed from the insulating coating 24 is electrically connected to the first terminal 21.

### (Configuration of Corrugated Tube 25)

The corrugated tube 25 has a bellows structure in which a ring-shaped projection 26 and a ring-shaped recess 27 that has a smaller outer diameter than the projection 26 are provided alternatingly in the length direction X. The corrugated tube 25 is flexible.

For example, electroconductive resin materials or non-electroconductive resin materials can be used as the material of the corrugated tube 25. For example, synthetic resins such as polyolefins, polyamides, polyesters, and ABS resins can be used as resin materials.

The first electric wire 22 and an end portion of the corrugated tube 25 that is drawn out from the protector 40 are fixed to one another using a fixing member 28 such as a piece of tape, for example. The fixing member 28 is wrapped around the entire circumference of the first electric wire 22 and the end portion of the corrugated tube 25. Thus, relative movement of the corrugated tube 25 and the first electric wire 22 relative to one another is restricted.

### (Configuration of Second Electric Wire Member 30)

The second electric wire member 30 includes a second terminal 31 and a second electric wire 32 that is connected to the second terminal 31.

The second terminal 31 and the second electric wire 32 have the same configurations as the first terminal 21 and the first electric wire 22, respectively. Thus, in regard to the components of the second electric wire member 30, redundant description is omitted by providing the components of the second electric wire member 30 with reference symbols “3*” obtained by adding “10” to the reference symbols “2*” indicating the components of the first electric wire member 20.

### (Configuration of Protector 40)

As illustrated in FIG. 1, the protector 40 includes a protector main body 50, a first cover 60, a second cover 70, and a bolt 80 that is provided to the protector main body 50.

For example, the protector main body 50, the first cover 60, and the second cover 70 are each formed from a synthetic resin such as a polypropylene or a polyamide. If the protector 40 is to be exposed to a high-temperature environment due to being placed near a heat source or other similar reasons, it is preferable that polyamides, which have higher heat resistance than polypropylenes, be used as the materials for forming the protector main body 50, the first cover 60, and the second cover 70.

### (Configuration of Protector Main Body 50)

As illustrated in FIGS. 1 and 2, the protector main body 50 includes a first arrangement portion 51 and a second arrangement portion 52. The first electric wire 22 is arranged in the first arrangement portion 51. A connection portion C between the first terminal 21 and the second terminal 31 is arranged in the second arrangement portion 52. Note that the first cover 60 is a cover that covers the first arrangement portion 51. The second cover 70 is a cover that covers the second arrangement portion 52.

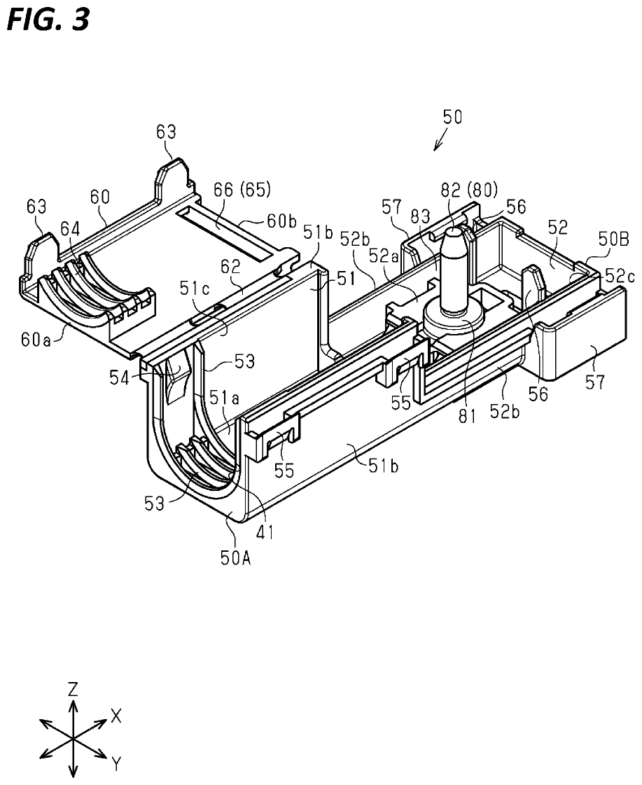

As illustrated in FIGS. 2 and 3, the first arrangement portion 51 includes a first bottom wall 51a that extends in the length direction X, two mutually-facing second side walls 52b that project from the opposite side edges of the first bottom wall 51a, and a first opening 51c that faces the first bottom wall 51a. The first opening 51c is formed by the two first side walls 51b.

The second arrangement portion 52 includes a second bottom wall 52a that extends in the length direction X for example, two mutually-facing second side walls 52b that project from the opposite side edges of the second bottom wall 52a, and a second opening 52c that faces the second bottom wall 52a. The second bottom wall 52a is contiguous with the first bottom wall 51a. The second side walls 52b extend in the length direction X from the first side walls 51b. The second opening 52c is formed by the two second side walls 52b.

The protector main body 50 includes a first end portion 50A and a second end portion 50B that are respectively located at one side and the other side in the length direction X. The first electric wire member 20 is drawn out from the first end portion 50A. The second electric wire member 30 is drawn out from the second end portion 50B. The first arrangement portion 51 is provided in the first end portion 50A-side of the protector main body 50 in the length direction X. The second arrangement portion 52 is provided in the second end portion 50B-side of the protector main body 50 in the length direction X.

The protector 40 includes, in the first end portion 50A-side end portion thereof, a lead-out port 41 through which the first electric wire member 20 is led out to the outside of the protector 40. The corrugated tube 25 and the insulating coating 24 of the first electric wire 22 are located inside the lead-out port 41. In other words, the exposed part of the core wire 23 at the tip of the first electric wire 22 is arranged inside the protector 40.

An engaging projection 53 that is fitted into the recess 27 of the corrugated tube 25 is provided on the inner surface of the first arrangement portion 51. For example, a plurality of engaging projections 53 are provided with spaces therebetween in the length direction X. For example, the engaging projections 53 each have an arcuate shape extending along the outer circumferential surface of the recess 27. Furthermore, the engaging projections 53 are provided near the first end portion 50A of the protector main body 50, for example. Furthermore, the engaging projections 53 are provided contiguously from the first bottom wall 51a to each second side wall 52b, for example.

As illustrated in FIGS. 1 and 3, retainer protrusions 54 that prevent the coming out of the corrugated tube 25 from the first opening 51c are provided on the inner surfaces of the first side walls 51b. As a result of the corrugated tube 25 arranged in the first arrangement portion 51 contacting the retainer protrusions 54, the corrugated tube 25 is prevented from being coming out from the first opening 51c.

### (Configuration of First Cover 60)

As illustrated in FIGS. 2 and 3, the first cover 60 covers the first opening 51c. Thus, the first cover 60 covers the first electric wire 22 arranged in the first arrangement portion 51.

For example, the first cover 60 is integrally molded with the protector main body 50. Specifically, the first cover 60 is connected to one of the first side walls 51b via a hinge portion 62. Furthermore, the first cover 60 includes first engaging portions 63 that engage with first lock portions 55 that are provided on the other first side wall 51b. The first opening 51c is opened and closed as a result of the first cover 60 rotating about the hinge portion 62 as a fulcrum. Furthermore, the first cover 60 is held in a closed state in which the first cover 60 covers the first opening 51c as a result of the first engaging portions 63 being engaged with the first lock portions 55.

The first cover 60 includes a first end portion 60a and a second end portion 60b that are respectively located at one side and the other side in the length direction X. For example, the first end portion 60a of the first cover 60 is located at the same position as the first end portion 50A of the protector main body 50 in the length direction X. The second end portion 60b of the first cover 60 faces the second arrangement portion 52.

An engaging projection 64 that is fitted into a recess 27 of the corrugated tube 25 is provided on the inner surface of the first cover 60 facing the first arrangement portion 51. For example, a plurality of engaging projections 64 are provided with spaces therebetween in the length direction X. For example, the engaging projections 64 each have an arcuate shape extending along the outer circumferential surface of a recess 27. The engaging projections 64 are provided near the first end portion 60a of the first cover 60, for example. For example, the engaging projections 64 of the first cover 60 are located at the same positions as the engaging projections 53 of the first arrangement portion 51 in the length direction X. Thus, the engaging projections 53 and the engaging projections 64 sandwich the corrugated tube 25 from opposite sides in the radial direction. The corrugated tube 25 is restricted from moving in the length direction X as a result of the engaging projections 53 and the engaging projections 64 fitting into recesses 27 of the corrugated tube 25.

### (Configuration of First Locking Portion 65)

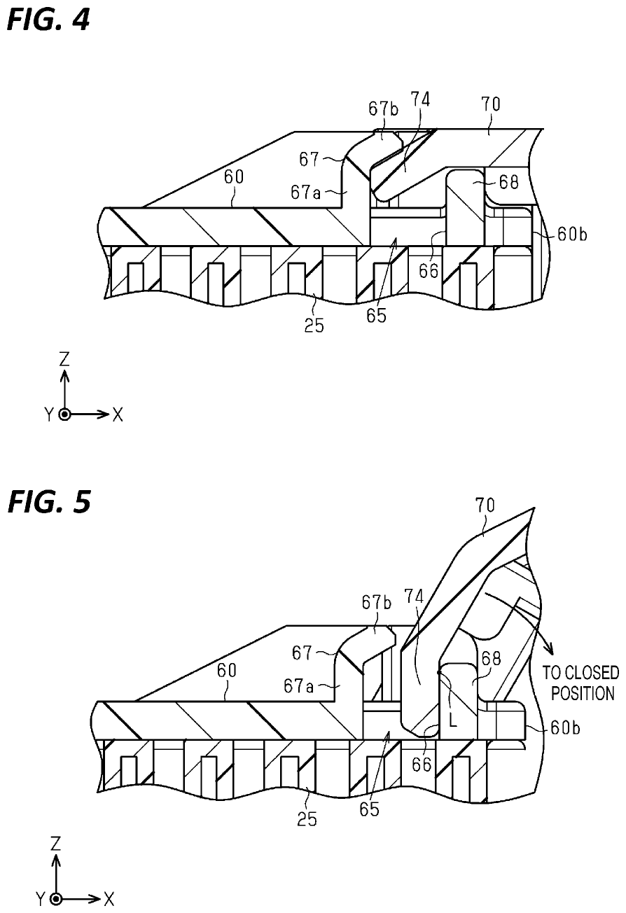

The first cover 60 includes a first locking portion 65 in the second end portion 60b thereof. As illustrated in FIG. 4, the first locking portion 65 includes a slit 66. For example, the slit 66 is formed along a width direction Y of the protector 40, which is orthogonal to the length direction X. Note that the length direction X, the width direction Y, and a height direction Z are mutually orthogonal directions. For example, the slit 66 passes through the first cover 60 along the height direction Z of the protector 40.

Furthermore, the first locking portion 65 includes a first wall portion 67 and a second wall portion 68 that form the slit 66, for example. The first wall portion 67 and the second wall portion 68 each project from the outer surface of the first cover 60. Furthermore, the first wall portion 67 and the second wall portion 68 each extend linearly along the width direction Y. In other words, the first wall portion 67 and the second wall portion 68 face one another in the length direction X, and the slit 66 is formed between the first wall portion 67 and the second wall portion 68.

The second wall portion 68 is provided between the first wall portion 67 and the second end portion 60b of the first cover 60. In other words, out of the first wall portion 67 and the second wall portion 68, the second wall portion 68 is provided at a position closer to the second end portion 60b.

The first wall portion 67 includes a base portion 67a that extends along the height direction Z, and an inclined portion 67b that extends from the tip portion of the base portion 67a while inclining with respect to the height direction Z. The base portion 67a faces the second wall portion 68 in the length direction X. The inclined portion 67b is inclined so that the distance to the second wall portion 68-side/second arrangement portion 52-side decreases commensurately toward the tip-side thereof.

### (Configuration of Second Arrangement Portion 52)

As illustrated in FIGS. 2 and 3, the second arrangement portion 52 includes the bolt 80 on the second bottom wall 52a. The bolt 80 includes a head portion 81 that is fixed to the second bottom wall 52a, and a male thread portion 82 that projects toward the second opening 52c from the head portion 81. The male thread portion 82 projects in a direction that is oriented along the height direction Z of the protector 40, which is orthogonal to the length direction X. In the height direction Z, the height of the male thread portion 82 is set higher than the height of the second side walls 52b. Thus, the male thread portion 82 is exposed from the protector main body 50.

As illustrated in FIG. 2, the protector 40 includes a fixing portion 42 for fixing the head portion 81 of the bolt 80 to the second bottom wall 52a. The fixing portion 42 covers the head portion 81 so that the head portion 81 is not exposed to the outside on the lower surface-side of the protector main body 50. Note that the fixing portion 42 may be integrally molded with the protector main body 50, or may be formed separately from the protector main body 50. Furthermore, in a case in which the fixing portion 42 is integrally molded with the protector main body 50, the fixing portion 42 may be connected to the protector main body 50 via a hinge portion and configured so that the fixing portion 42 can be opened and closed about the hinge portion.

As illustrated in FIGS. 1 and 2, the male thread portion 82 is inserted into the through-hole 21a in the first terminal 21 and a through-hole 31a in the second terminal 31. Furthermore, the first terminal 21 and the second terminal 31 are fastened together as a result of a nut 83 being screwed onto the male thread portion 82. In the present embodiment, the portion that is fastened by the bolt 80 and the nut 83 is the connection portion C between the first terminal 21 and the second terminal 31. The first terminal 21, the second terminal 31, and the connection portion C are arranged in the second arrangement portion 52.

The height in the height direction Z of the second side walls 52b of the second arrangement portion 52 is set low. Specifically, the height of the second side walls 52b is set so that the nut 83 does not overlap the second side walls 52b when seen from the width direction Y. Such a height is set to ensure that there is enough handling space when a worker attaches the nut 83 to the male thread portion 82.

The second arrangement portion 52 includes a rotation-restricting portion 56 that restricts the rotation of the second terminal 31 in the circumferential direction around the bolt 80. For example, the rotation-restricting portion 56 is provided on both sides of the second terminal 31 in the width direction Y. For example, the rotation-restricting portions 56 extend toward the inside of the second arrangement portion 52 from the inner surfaces of the second side walls 52b. The rotation-restricting portions 56 are configured to be capable of coming into contact with the second terminal 31 in the circumferential direction around the bolt 80. Specifically, the second terminal 31 can come into contact with one rotation-restricting portion 56 during fastening of the nut 83, and the second terminal 31 can come into contact with the other rotation-restricting portion 56 during removal of the nut 83.

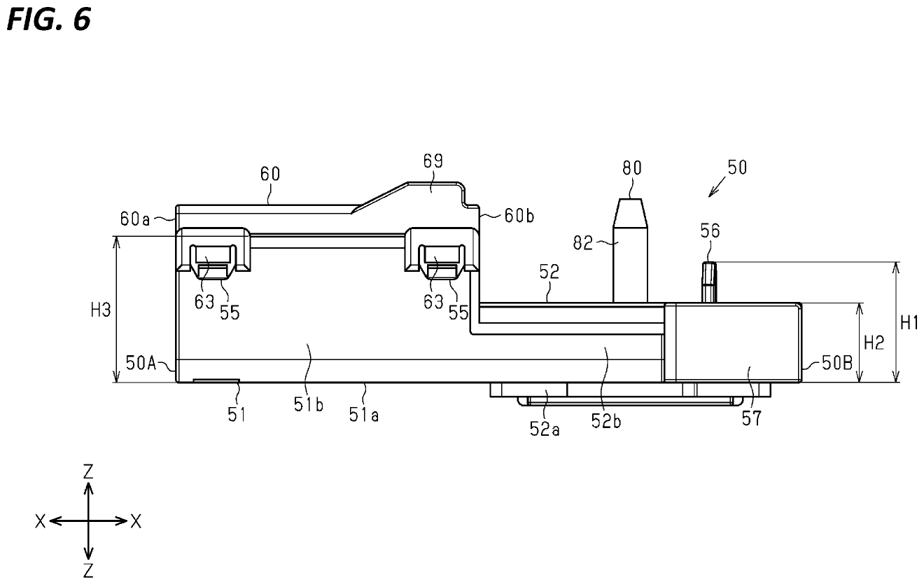

As illustrated in FIG. 6, in the height direction Z, a height H1 of the rotation-restricting portions 56 relative to the second bottom wall 52a is set higher than a height H2 of the second side walls 52b relative to the second bottom wall 52a. Thus, it becomes possible to allow the second terminal 31 to come into contact with the rotation-restricting portions 56 while ensuring that there is enough handling space by reducing the height H2 of the second side walls 52b. Furthermore, a height H3 of the first side walls 51b is set higher than the height H2 of the second side walls 52b.

### (Configuration of Second Cover 70)

The second cover 70 covers the second opening 52c of the second arrangement portion 52. Thus, the second cover 70 covers the first terminal 21, the second terminal 31, and the connection portion C, which are arranged in the second arrangement portion 52.

The second cover 70 is formed separately from the protector main body 50 and the first cover 60. The second cover 70 includes a first end portion 70a and a second end portion 70b that are respectively located at one side and the other side in the length direction X. For example, the second end portion 70b of the second cover 70 is located at the same position as the second end portion 50B of the protector main body 50 in the length direction X. Furthermore, the first end portion 70a of the second cover 70 faces the first cover 60-side in the length direction X.

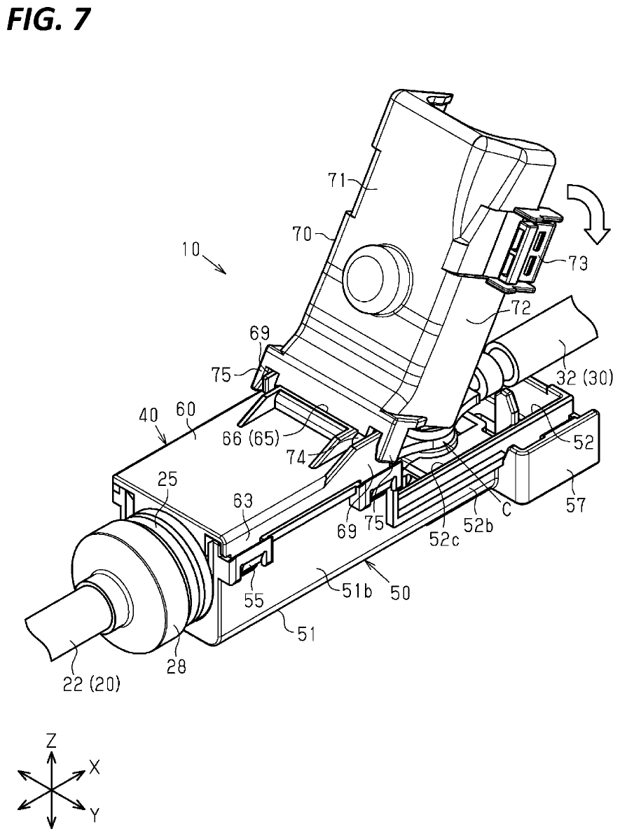

As illustrated in FIGS. 1 and 7, for example, the second cover 70 includes a top wall 71 that extends in the length direction X and faces the second bottom wall 52a, and two mutually-facing side walls 72 that project from the opposite side edges of the top wall 71.

The side walls 72 of the second cover 70 include second engaging portions 73 that engage with second lock portions 57 provided on the second side walls 52b of the second arrangement portion 52. The second lock portions 57 on the second side walls 52b are located closer to the second end portion 50B in the length direction X than the male thread portion 82 of the bolt 80 is.

### (Configuration of Second Locking Portion 74)

The second cover 70 includes a second locking portion 74 that lockingly engages with the first locking portion 65 of the first cover 60. The second locking portion 74 has a flat shape that can be inserted into the slit 66 in the first locking portion 65. The second locking portion 74 extends along the width direction Y. The second cover 70 is configured to be capable of rotating about a contact portion between the first locking portion 65 and the second locking portion 74 as a fulcrum from an open position illustrated in FIG. 7 to a closed position in which the second cover 70 covers the second arrangement portion 52.

As illustrated in FIG. 4, the second locking portion 74 is inclined further toward the inside of the protector 40 commensurately as the distance toward the tip side in the length direction X increases. Note that FIG. 4 illustrates a state of engagement between the first locking portion 65 and the second locking portion 74 when the second cover 70 is in the closed position. When the second cover 70 is in the closed position, the second locking portion 74 is in contact with the inclined portion 67b of the first locking portion 65 in a state in which the second locking portion 74 is substantially parallel with the inclined portion 67b. In other words, the second locking portion 74 is in surface contact with the inclined portion 67b.

Upon attaching the second cover 70, first, the second locking portion 74 is inserted into the slit 66 in the first cover 60 in the closed state. Here, the second locking portion 74 is inserted into the space between the tip of the inclined portion 67b and the tip of the second wall portion 68.

FIG. 5 illustrates a state of engagement between the first locking portion 65 and the second locking portion 74 when the second cover 70 is in the open position. When the second cover 70 is in the open position, the second locking portion 74 is located between the first wall portion 67 and the second wall portion 68. Thus, the second cover 70 is held in the open position. Furthermore, the second cover 70 is capable of rotating from the open position to the closed position about the contact portion between the second locking portion 74 and the tip portion of the second wall portion 68 as an axis of rotation L. For example, the axis of rotation L extends along the width direction Y.

As illustrated in FIGS. 1 and 7, in the first cover 60, a projecting portion 69 that projects from the upper surface of the first cover 60 is provided on both sides of the first locking portion 65 in the width direction Y. On the other hand, in the second cover 70, a positioning portion 75 that faces the second locking portion 74 with a gap therebetween is formed on both sides of the second locking portion 74 in the width direction Y. The projecting portion 69 of the first cover 60 is inserted into the space between the second locking portion 74 and the positioning portion 75. Thus, the second cover 70 is positioned relative to the first cover 60 in the width direction Y.

### (Manner of Assembly of Wire Harness 10)

Upon assembly of the wire harness 10, first, the first cover 60 is opened, and the second cover 70 is removed from the protector main body 50. In this state, the corrugated tube 25 of the first electric wire member 20 is housed in the first arrangement portion 51 through the first opening 51c. Furthermore, in doing so, the first terminal 21 is arranged in the second arrangement portion 52 such that the male thread portion 82 of the bolt 80 is inserted into the through-hole 21a in the first terminal 21.

Next, the first cover 60 is rotated about the hinge portion 62 to a closed position in which the first cover 60 covers the first opening 51c, and the first engaging portions 63 are engaged with the first lock portions 55. Thus, the first cover 60 is held in the closed position. In a state in which the first cover 60 is in the closed position, the corrugated tube 25 is sandwiched between the first cover 60 and the first bottom wall 51a in the height direction Z. Thus, the first electric wire member 20 is held by the protector main body 50. Furthermore, here, the first terminal 21 is fitted onto the male thread portion 82 of the bolt 80. Thus, the movement of the first terminal 21 in the length direction X and the width direction Y is restricted by the male thread portion 82 of the bolt 80. Accordingly, the first electric wire member 20 can be more reliably held against the protector main body 50 in a state before the nut 83 is fastened to the bolt 80. Due to this, the wire harness 10 can be transported and distributed with ease in a state in which the first electric wire member 20 has been attached to the protector main body 50 and the second electric wire member 30 is yet to be connected to the first electric wire member 20.

Next, the first electric wire member 20 and the protector 40 attached to the first electric wire member 20 are installed to an installation location in a vehicle. Here, the second electric wire member 30 has not been connected to the first electric wire member 20 yet, and the second cover 70 also has not been attached to the protector main body 50 yet. Thus, the first terminal 21 and the male thread portion 82 of the bolt 80 are exposed from the protector main body 50.

Next, the second terminal 31 of the second electric wire member 30, which has been separately routed in the vehicle, is fitted onto the male thread portion 82 and placed over the first terminal 21. Then, the nut 83 is attached to the male thread portion 82. Thus, the first terminal 21 and the second terminal 31 are fastened together. Note that, during the fastening of the nut 83, the second terminal 31 is preferably placed into contact with one of the rotation-restricting portions 56. Furthermore, because a configuration is adopted in which the bolt 80 is not covered by the first cover 60, the work of attaching the nut 83 can be performed with ease.

Next, the second cover 70 is attached to the second arrangement portion 52, which is in a state in which the first terminal 21, the second terminal 31, and the connection portion C have been arranged therein. Here, first, the second locking portion 74 of the second cover 70 is inserted into the slit 66 in the first cover 60. Then, the second cover 70 is rotated to the closed position about the contact portion between the second locking portion 74 and the second wall portion 68 forming the slit 66 as the axis of rotation L, and the second engaging portions 73 are engaged with the second lock portions 57. Thus, the second cover 70 is held in the closed position, in which the second cover 70 covers the second arrangement portion 52. Here, the second end portion 70b-side of the second cover 70 is fixed by the second engaging portions 73 and the second lock portions 57 engaging with one another; on the other hand, on the first end portion 70a-side of the second cover 70, the second locking portion 74 does not readily separate from the slit 66 as a result of the contact with the inclined portion 67b.

Effects of the present embodiment will be described.
(1) A protector 40 includes: a protector main body 50 that includes a first arrangement portion 51 and a second arrangement portion 52; a first cover 60 that covers the first arrangement portion 51; and a second cover 70 that covers the second arrangement portion 52. A first electric wire 22 is arranged in the first arrangement portion 51. A connection portion C between the first terminal 21 and the second terminal 31 is arranged in the second arrangement portion 52. The second cover 70 is formed separately from the protector main body 50 and the first cover 60. The first cover 60 includes a first locking portion 65. The second cover 70 includes a second locking portion 74 that lockingly engages with the first locking portion 65. Furthermore, the second cover 70 is configured to be capable of rotating about a contact portion between the first locking portion 65 and the second locking portion 74 as an axis of rotation L from an open position to a closed position in which the second cover 70 covers the second arrangement portion 52.

According to this configuration, first, the first cover 60 is attached in a state in which the first electric wire member 20 is arranged in the protector main body 50. Here, the first terminal 21 is exposed from the protector 40 as a result of the second cover 70 being removed. Thus, the first terminal 21 and the second terminal 31 can be connected to one another inside the protector main body 50 in a state in which the first cover 60 is attached to the protector main body 50. Furthermore, the second cover 70 can then be attached to the protector main body 50 to cover the connection portion C between the first terminal 21 and the second terminal 31 with the second cover 70. Upon attaching the second cover 70, the second locking portion 74 is lockingly engaged with the first locking portion 65, and the second cover 70 is rotated to the closed position about the contact portion between the first locking portion 65 and the second locking portion 74 as the axis of rotation L. Thus, the work of attaching the second cover 70 can be performed using one hand, and the workability during the work of attaching the second cover 70 can be improved.

Furthermore, the second cover 70 is formed separately from the protector main body 50 and the first cover 60. Here, for example, in a case in which the second cover 70 is integrally molded with the protector main body 50 via a hinge or the like, the hinge would also be formed from a synthetic resin such as a polyamide. Polyamides have excellent heat resistance but are vulnerable to dryness. Thus, if the installation of the wire harness 10 to a vehicle, or specifically the connection of the first terminal 21 and the second terminal 31 to one another and the attachment of the second cover 70, is performed in a dry environment such as a cold area, the hinge may break when the second cover 70 is rotated about the hinge. In this regard, in a configuration as in the present embodiment in which the second cover 70 is formed separately from the protector main body 50 and the first cover 60, there would be no concern that a hinge may break.
(2) The first locking portion 65 includes a slit 66 that is provided in the first cover 60. Furthermore, the second locking portion 74 is configured to be capable of being inserted into the slit 66. According to this configuration, the second cover 70 can be rotated to the closed position about a contact portion between the slit 66 and the second locking portion 74 as the axis of rotation after the second locking portion 74 is inserted into the slit 66.
(3) The first locking portion 65 can hold the second cover 70 in the open position in a state in which the axis of rotation L intersects a horizontal plane. According to this configuration, the workability during the work of attaching the second cover 70 can be further improved because the second cover 70 can be held in the open position in a state in which the second locking portion 74 is inserted into the slit 66.
(4) The slit 66 is formed between a first wall portion 67 and a second wall portion 68 that face one another. The second wall portion 68 is provided between the first wall portion 67 and a second end portion 60b of the first cover 60 that faces the second cover 70. A tip portion of the first wall portion 67 includes an inclined portion 67b that is inclined toward the second wall portion 68-side. Furthermore, the second locking portion 74 is in contact with the inclined portion 67b in a state in which the second cover 70 is in the closed position. According to this configuration, in the state in which the second cover 70 is in the closed position, the second locking portion 74 can be held by the inclined portion 67b so that the second locking portion 74 does not separate from the slit 66.
(5) A bolt 80 is fixed to the protector main body 50. The first terminal 21 includes a through-hole 21a into which the bolt 80 is inserted. Furthermore, the first terminal 21 and the second terminal 31 are connected to one another by the bolt 80 and a nut 83 that is screwed onto the bolt 80. According to this configuration, because the first terminal 21 includes the through-hole 21a, into which the bolt 80 is inserted, the movement of the first terminal 21 can be restricted even in a state, prior to the fastening of the nut 83, in which the bolt 80 is merely inserted into the through-hole 21a. Accordingly, the first electric wire member 20 can be more reliably held against the protector main body 50 in a state before the nut 83 is fastened to the bolt 80. Due to this, the wire harness 10 can be transported and distributed with ease in a state in which the first electric wire member 20 has been attached to the protector main body 50 and the second electric wire member 30 is yet to be connected to the first electric wire member 20.
(6) The second arrangement portion 52 includes a rotation-restricting portions 56 that restricts a rotation of the second terminal 31 about the bolt 80. The rotation-restricting portion 56 is located further inward in the protector 40 than a second end portion 50B of the protector 40 from which the second electric wire member 30 is led out is. According to this configuration, co-rotation of the second terminal 31 during fastening or removal of the nut 83 can be suppressed by the rotation-restricting portion 56.
(7) The first arrangement portion 51 and the first cover 60 sandwich the first electric wire member 20. According to this configuration, the first electric wire member 20 can be more reliably held in the protector 40. Due to this, the wire harness 10 can be transported and distributed with ease in a state in which the first electric wire member 20 has been attached to the protector main body 50 and the second electric wire member 30 is yet to be connected to the first electric wire member 20.
(8) The first arrangement portion 51 includes an engaging projection 53 as a movement-restricting portion that restricts a movement of the first electric wire member 20 in a length direction X. According to this configuration, the first electric wire member 20 can be more reliably held in the protector 40 by the engaging projection 53. Due to this, the wire harness 10 can be transported and distributed with ease in a state in which the first electric wire member 20 has been attached to the protector main body 50 and the second electric wire member 30 is yet to be connected to the first electric wire member 20.
(9) The first arrangement portion 51 includes a first bottom wall 51a and two mutually-facing first side walls 51b that project from opposite side edges of the first bottom wall 51a. The second arrangement portion 52 includes a second bottom wall 52a and two mutually-facing second side walls 52b that project from opposite side edges of the second bottom wall 52a. The engaging projection 53 is provided to at least the first side walls 51b of the first arrangement portion 51. Furthermore, a height H3 of the first side walls 51b is set higher than a height H2 of the second side walls 52b. According to this configuration, it can be readily ensured that the engaging projection 53 provided to the first side walls 51b has sufficient length, and, due to this, the restriction of the movement of the first electric wire member 20 by the engaging projection 53 can be realized more suitably. Furthermore, by reducing the height of the second side walls 52b, a situation can be prevented in which the second side walls 52b interfere with work of connecting the first terminal 21 and the second terminal 31 to one another. This accordingly contributes to an improvement in workability during work of connecting the first terminal 21 and the second terminal 31 to one another.
(10) The first electric wire member 20 includes a corrugated tube 25 that covers an outer circumference of the first electric wire 22. The corrugated tube 25 has a bellows structure in which a ring-shaped projection 26 and a ring-shaped recess 27 that has a smaller outer diameter than the projection 26 are provided alternatingly in the length direction X. Furthermore, the engaging projection 53, which is the movement-restricting portion, engages with the recess 27 of the corrugated tube 25. According to this configuration, the movement of the first electric wire member 20, which includes the corrugated tube 25, in the length direction X can be restricted as a result of the engaging projection 53 engaging with a recess 27 of the corrugated tube 25.
(11) The protector 40 includes a lead-out port 41 through which the first electric wire member 20 is led to the outside of the protector 40. An insulating coating 24 of the first electric wire 22 is located inside the lead-out port 41. According to this configuration, an exposed part of a core wire 23 in the first electric wire 22 can be arranged inside the protector 40.
(12) The second cover 70 includes a first end portion 70a that includes the second locking portion 74, a second end portion 70b on the opposite side from the first end portion 70a, and a second engaging portion 73. The second arrangement portion 52 includes a second lock portion 57 that engages with the second engaging portion 73 in a state in which the second cover 70 is in the closed position. The second lock portion 57 is located closer to the second end portion 70b than the connection portion C is in the length direction X. According to this configuration, the first end portion 70a of the second cover 70 can be held by the second locking portion 74 and the first locking portion 65 being locked to one another, and the second end portion 70b of the second cover 70 can be held by the second engaging portion 73 and the second lock portion 57 engaging with one another. Thus, both end portions of the second cover 70 can be held, and, due to this, the state of attachment of the second cover 70 can be stabilized.
(13) The first cover 60 is connected to the first arrangement portion 51 via a hinge portion 62. The first cover 60 is configured to be capable of rotating about the hinge portion 62 between an open position and a closed position in which the first cover 60 covers the first arrangement portion 51. According to this configuration, the first cover 60, which can open and close relative to the first arrangement portion 51, can be formed integrally with the first arrangement portion 51.

The present embodiment can be modified and implemented as follows. The present embodiment and the following modifications can be combined with one another as long as they are not technically contradictory.
The second electric wire member 30 can be omitted from the wire harness 10.
The corrugated tube 25 can be omitted from the first electric wire member 20. In this case, a configuration may be adopted such that the first arrangement portion 51 and the first cover 60 directly contact the first electric wire 22.
The first cover 60 may be formed separately from the protector main body 50.
The bolt 80 may project so as to be inclined relative to the second bottom wall 52a.
The bolt 80 may be insert-molded to the protector main body 50.
The connection structure between the first terminal 21 and the second terminal 31 is not limited to fastening by the bolt 80 and the nut 83, and may be changed to a different connection structure. That is, the bolt 80 can be omitted from the protector main body 50.
A configuration may be adopted such that the height H3 of the first side walls 51b is equal to or lower than the height H2 of the second side walls 52b.
The position of the second lock portions 57 in the length direction X may be changed to the same position as the bolt 80 or to a position that is closer to the first arrangement portion 51 than the bolt 80 is.
For example, in a case such as that in which the second electric wire member 30 includes a corrugated tube similar to that of the first electric wire member 20, the rotation-restricting portions 56 can be omitted from the second arrangement portion 52.
Configurations such as the shapes of the first locking portion 65 and the second locking portion 74 are not limited to those in the above-described embodiment, and can be changed, as appropriate, in accordance with the configuration of the protector 40.
In the above-described embodiment, the length directions of the first electric wire member 20 and the second electric wire member 30 are oriented along the same direction; however, there is no limitation to this, and a configuration may be adopted such that the length direction of the first electric wire member 20 and the length direction of the second electric wire member 30 intersect.
As illustrated in FIG. 1, the second cover 70 may be provided so as to be separable from the first cover 60 and the protector main body 50. According to this configuration, the second cover 70 can be attached to the first cover 60 and the protector main body 50 after the electric wire members 20 and 30 are connected to one another. Such a configuration is also advantageous in that the work of connecting the electric wire members 20 and 30 to one another can be performed in a state in which the second cover 70 is separated from the first cover 60 and the protector main body 50.
As illustrated in FIG. 4, in a state in which the second cover 70 is in the closed position, the lower surface of the inclined portion 67b of the first cover 60 may be in contact with the upper surface of the second locking portion 74 of the second cover 70. This configuration is advantageous to suppress the rattling of the second cover 70 inside the slit 66 and the separation of the second cover 70 from the slit 66. As illustrated in FIG. 4, in the state in which the second cover 70 is in the closed position, the second cover 70 may be supported from below by the first cover 60, e.g., the second wall portion 68.
As illustrated in FIG. 5, when the second cover 70 is in the open position and the second wall portion 68 of the first cover 60 is holding the second cover 70 in the open position by being in surface contact with the second locking portion 74 of the second cover 70, the first locking portion 65 may include a relatively wide space for allowing the second locking portion 74 to rotate in the slit 66 upon moving between the open position and the closed position. This configuration is advantageous to hold the second cover 70 stably in the open position and allow the second cover 70 to smoothly rotate from the open position to the closed position.
As illustrated in FIG. 5, a configuration may be adopted such that, when the second cover 70 is in the open position, one of the first wall portion 67 and the second wall portion 68 (e.g., the second wall portion 68) is in contact with the second locking portion 74, and the other of the first wall portion 67 and the second wall portion 68 (e.g., the first wall portion 67) is not in contact with the second locking portion 74 of the second cover 70.
The first wall portion 67 (inclined portion 67b) of the first cover 60 may be referred to as a closed-position stopper that is configured to be in contact with the second locking portion 74 of the second cover 70 when the second cover 70 is in the closed position, as illustrated in FIG. 4. The second wall portion 68 of the first cover 60 may be referred to as an open-position stopper that is configured to be in contact with the second locking portion 74 of the second cover 70 when the second cover 70 is in the open position, as illustrated in FIG. 5.
As illustrated in FIGS. 1 and 7, the first cover 60 may include two projecting portions 69 that are provided on opposite sides of the first locking portion 65 in the width direction Y. Each projecting portions 69 may project from the upper surface of the first cover 60. The second cover 70 may include two positioning portions 75 that are provided on opposite sides of the second locking portion 74 in the width direction Y. Each positioning portion 75 may face the second locking portion 74 across a gap or a groove-like space. Each projecting portion 69 of the first cover 60 may be inserted into a groove-like space between a positioning portion 75 and the second locking portion 74 of the second cover 70. This configuration is advantageous to position the second cover 70 relative to the first cover 60 in the width direction Y.
As illustrated in FIG. 4, when the second cover 70 is in the closed position, a plate-shaped tip portion (e.g., the upper surface of the tip portion) of the second locking portion 74 of the second cover 70 may overlap in the height direction Z and be in contact in the height direction Z with a plate-shaped tip portion (e.g., the lower surface of the tip portion) of the first wall portion 67 of the first locking portion 65 inside the slit 66 in the first locking portion 65.
As illustrated in FIG. 2, the second cover 70 may cover the first arrangement portion 51 and the second arrangement portion 52 in cooperation with the first cover 60. For example, the first cover 60 need not cover the second arrangement portion 52, and the second cover 70 need not cover the first arrangement portion 51.
As illustrated in FIG. 1, when the second cover 70 is in the open position, the connection portion C between the first terminal 21 and the second terminal 31 may be exposed from the protector main body 50 in a predetermined angular position in the circumferential direction of the wire harness 10. As illustrated in FIG. 2, when the second cover 70 is in the closed position, the protector main body 50 and the second cover 70 may surround the connection portion C between the first terminal 21 and the second terminal 31 in the circumferential direction of the wire harness 10.
The embodiment and modifications disclosed herein are examples in every way, and the present invention is not limited by these examples. That is, the scope of the present invention is intended to include all modifications that are indicated by the claims and are within the meaning and scope of equivalents of the claims.

### LIST OF REFERENCE NUMERALS

10 Wire harness
20 First electric wire member
21 First terminal
21a Through-hole
22 First electric wire
23 Core wire
24 Insulating coating
25 Corrugated tube
26 Projection
27 Recess
28 Fixing member
30 Second electric wire member
31 Second terminal
31a Through-hole
32 Second electric wire
40 Protector
41 Lead-out port
42 Fixing portion
50 Protector main body
50A First end portion
50B Second end portion
51 First arrangement portion
51a First bottom wall
51b First side wall
51c First opening
52 Second arrangement portion
52a Second bottom wall
52b Second side wall
52c Second opening
53 Engaging projection (movement-restricting portion)
54 Retainer protrusion
55 First lock portion
56 Rotation-restricting portion
57 Second lock portion (lock portion)
60 First cover
60a First end portion
60b Second end portion
62 Hinge portion
63 First engaging portion
64 Engaging projection
65 First locking portion
66 Slit
67 First wall portion
67a Base portion
67b Inclined portion
68 Second wall portion
69 Projecting portion
70 Second cover
70a First end portion
70b Second end portion
71 Top wall
72 Side wall
73 Second engaging portion (engaging portion)
74 Second locking portion
75 Positioning portion
80 Bolt
81 Head portion
82 Male thread portion
83 Nut
C Connection portion
H1 Height
H2 Height
H3 Height
L Axis of rotation
X Length direction
Y Width direction
Z Height direction

1. A wire harness comprising: a first electric wire member that includes a first terminal and a first electric wire that is connected to the first terminal; and a protector that houses the first electric wire member therein, the first terminal being connected, inside the protector, to a second terminal that is included in a second electric wire member,
wherein the protector includes:
a protector main body that includes a first arrangement portion in which the first electric wire is arranged, and a second arrangement portion in which a connection portion between the first and second terminals is arranged;
a first cover that covers the first arrangement portion; and
a second cover that is formed separately from the protector main body and the first cover, and that covers the second arrangement portion,
the first cover includes a first locking portion,
the second cover includes a second locking portion that lockingly engages with the first locking portion, and
the second cover is configured to be capable of rotating about a contact portion between the first and second locking portions as an axis of rotation from an open position to a closed position in which the second cover covers the second arrangement portion.

2. The wire harness according to claim 1,
wherein the first locking portion includes a slit that is provided in the first cover, and
the second locking portion is configured to be capable of being inserted into the slit.

3. The wire harness according to claim 2,
wherein the first locking portion can hold the second cover in the open position in a state in which the axis of rotation intersects a horizontal plane.

4. The wire harness according to claim 2,
wherein the slit is formed between a first wall portion and a second wall portion that face one another,
the second wall portion is provided between the first wall portion and an end portion of the first cover that faces the second cover,
a tip portion of the first wall portion includes an inclined portion that is inclined toward the second wall portion-side, and
the second locking portion is in contact with the inclined portion in a state in which the second cover is in the closed position.

5. The wire harness according to claim 1,
wherein a bolt is fixed to the protector main body,
the first terminal includes a through-hole into which the bolt is inserted, and
the first and second terminals are coupled to one another by the bolt and a nut that is screwed onto the bolt.

6. The wire harness according to claim 5,
wherein the second arrangement portion includes a rotation-restricting portion that restricts a rotation of the second terminal about the bolt, and
the rotation-restricting portion is located further inward in the protector than an end portion of the protector from which the second electric wire member is led out is.

7. The wire harness according to claim 1,
wherein the first arrangement portion and the first cover sandwich the first electric wire member.

8. The wire harness according to claim 1,
wherein the first arrangement portion includes a movement-restricting portion that restricts a movement of the first electric wire member in a length direction.

9. The wire harness according to claim 8,
wherein the first arrangement portion includes a first bottom wall, and two mutually-facing first side walls that project from opposite side edges of the first bottom wall,
the second arrangement portion includes a second bottom wall, and two mutually-facing second side walls that project from opposite side edges of the second bottom wall,
the movement-restricting portion is provided to at least the first side walls of the first arrangement portion, and
a height of the first side walls is set higher than a height of the second side walls.

10. The wire harness according to claim 8,
wherein the first electric wire member includes a corrugated tube that covers an outer circumference of the first electric wire,
the corrugated tube has a bellows structure in which a ring-shaped projection and a ring-shaped recess that has a smaller outer diameter than the projection are provided alternatingly in the length direction, and
the movement-restricting portion is an engaging projection that engages with the recess.

11. The wire harness according to claim 1,
wherein the protector includes a lead-out port through which the first electric wire member is led out to the outside of the protector, and
an insulating coating of the first electric wire is located inside the lead-out port.

12. The wire harness according to claim 1,
wherein the second cover includes a first end portion that includes the second locking portion, a second end portion on the opposite side from the first end portion, and an engaging portion,
the second arrangement portion includes a lock portion that engages with the engaging portion in a state in which the second cover is in the closed position, and
the lock portion is located closer to the second end portion than the connection portion is.

13. The wire harness according to claim 1,
wherein the first cover is connected to the first arrangement portion via a hinge portion, and
the first cover is configured to be capable of rotating about the hinge portion between an open position and a closed position in which the first cover covers the first arrangement portion.

14. A protector housing therein a first electric wire member that includes a first terminal and a first electric wire that is connected to the first terminal, the first terminal being connected, inside the protector, to a second terminal that is included in a second electric wire member, the protector comprising:
a protector main body that includes a first arrangement portion in which the first electric wire is arranged, and a second arrangement portion in which a connection portion between the first and second terminals is arranged;
a first cover that covers the first arrangement portion; and
a second cover that is formed separately from the protector main body and the first cover, and that covers the second arrangement portion,
the first cover including a first locking portion,
the second cover including a second locking portion that lockingly engages with the first locking portion, and
the second cover being configured to be capable of rotating about a contact portion between the first and second locking portions as an axis of rotation from an open position to a closed position in which the second cover covers the second arrangement portion.
